(19) United States
(12) Patent Application Publication
(10) Pub. No.: US 2003/0009765 A1
(43) Pub. Date: Jan. 9, 2003

(54) Multiple program burst broadcast

(76) Inventors: Thomas M. Linden, Los Gatos, CA (US); Donald F. Bogue, San Mateo, CA (US); Albert W. Wegener, Portola Valley, CA (US); Edward J. Costello, Pleasanton, CA (US); John M. Schoellerman, San Francisco, CA (US)

Correspondence Address: SKJERVEN MORRILL LLP, 25 METRO DRIVE, SUITE 700, SAN JOSE, CA, 95110, US

(21) Appl. No.: 09/887,863

(22) Filed: Jun. 22, 2001

(51) Int. Cl. H04H 1/00; H04N 7/173

(52) U.S. Cl. 725/95; 725/97; 455/3.01

(57) ABSTRACT

In an on-demand radio broadcast system in which the receivers have the capability to store received programs, a communications channel is divided into a plurality of time segments. Each time segment is partitioned into a high priority program timeslice and a low priority program timeslice. High priority programs are broadcast in each high priority program timeslice. The remaining programs are broadcast during a plurality of low priority program timeslices. This overcomes a problem of the receivers being out of contact and not having current versions of the high priority programs.

### BACKGROUND

1. Field of Invention

Wireless communication systems; in particular, wireless systems providing on-demand information to a human user by use of local program storage.

2. Related art

Consumer-oriented wireless (radio) communications systems that deliver selected on-demand programs (content) to users are available. Such systems typically include a mobile electronic device (e.g., a portable radio or video receiver) that receives pre-recorded programs via a wireless signal and locally stores the received programs for later output (playback) to the user. The user typically designates one or more of the stored programs for output by selecting the stored program(s) from a menu of selections output by the receiver. Hence, “on-demand” refers to receiver operation, not to transmission facility operation. Commonly owned U.S. Pat. Nos. 5,406,626 ('626); 5,524,051 ('051); 5,590,195 ('195); 5,751,806 ('806); 5,809,472 ('472); and 5,815,671 ('671); and U.S. patent application Ser. No. 09/454,901 ('901) each describe features of such systems, and all are incorporated herein by reference. An illustrative on-demand program delivery system is presently marketed by Command Audio Corporation, Redwood City, Calif. An illustrative receiver is the Command Audio Corporation part no. CA-1000.

For example, the '626, '051, and '195 patents disclose methods and systems for information dissemination using, in some embodiments, a dedicated system receiver. The disclosed service and system permit a user to listen to (or watch, or read a text display of) specific programs when and where the user chooses, independent of the program transmission time (i.e., program output time shifting). Examples of such programs are news, music, sports, and finance programs. Each unique program is digitized and broadcast using, for example, a radio frequency (RF) signal. The receiver, which is typically portable, extracts the digitized program (e.g., alphanumeric data, audio data, video data) from the received wireless signal. The receiver then stores each unique extracted program as one of a set of data files in a memory (e.g., semiconductor non-volatile RAM (NVRAM) or disk drive) within or closely associated with the receiver (local content storage). The receiver outputs to the user a menu structure (e.g., visual display, audio output) of selections, including selections corresponding to the stored programs. The user then selects at any later time one of the stored program data files for output by choosing a selection from the outputted menu structure using, for example, control buttons or voice commands. In some embodiments such an on-demand system operates using U.S. commercial FM station subcarriers to carry the program data.

Such on-demand system applications are not limited to use with commercial FM station capabilities. Other broadcast systems appropriate for on-demand service include Digital Audio Broadcast (DAB) (e.g., the in-band on-channel (IBOC) and hybrid IBOC systems currently developed as iDAB™ by the iBiquity Digital Corporation, Columbia Md.), satellite digital audio radio (SDAR) systems (e.g., proprietary systems of Sirius Satellite Radio, Inc., Washington, D.C. operating from 2320.0-2332.5 MHz, or XM Satellite Radio, Inc., New York, N.Y., operating from 2332.5-2345.0 MHz), or ensemble multiplex broadcast channel system (e.g., European Telecommunications Standards Institute (ETSI) Eureka-147 system, Sirius and XM systems). These systems typically include dynamic channel bandwidth allocation, by which the system operator dynamically alters the bandwidth allocated to a particular system channel. If the channel bandwidth is increased, the channel can carry an increased information payload.

FIG. 1 is a diagrammatic view of a known on-demand system. FIG. 1 illustrates a signal reception problem at certain wireless signal frequencies and/or reception power levels (e.g., problems encountered with signals from known SDAR systems). Transmitter 102 conventionally broadcasts wireless signal 104 using conventional transmitting antenna 106. Transmitter 102 may be a terrestrial transmitter or a satellite transmitter and relies on line-of-sight signal transmissions.

As shown in FIG. 1, physical obstruction 108 blocks direct signal path 110 between transmitting antenna 106 and receiving antenna 112 of on-demand system receiver 114 when receiver 114 is in position 115. Thus, in position 115 receiver 114 does not receive signal 104. Accordingly, if signal 104 includes programs for an on-demand broadcast system, receiver 114 does not receive the programs for local storage and subsequent playback if in position 115. For example, if receiver 114 is located in an automobile parked inside a residential garage, the garage structure surrounding the automobile acts as obstruction 108 and prevents signal 104 from reaching receiver 114. (Satellite signals especially tend to be of low power and hence easily obstructed.) When receiver 114 is moved to position 116, unobstructed signal path 118 exists between transmitting antenna 106 and receiving antenna 112 Therefore, receiver 114 in position 116 can receive signal 104 and on-demand system programs carried therein.

FIG. 2 is a diagrammatic view of an illustrative, simplified signal or program transmission structure for signal 104 as used in the on-demand system of FIG. 1. The letter “t” with the accompanying arrow represents time. As shown in FIG. 2, wireless signal 104 includes a number of consumer programs. For the purpose of this disclosure, “programs” are discrete media objects in a particular media or multimedia format (e.g., audio, video, text, graphics, or combinations thereof) that provide information or entertainment to a user. In some cases, one or more “programs” may include other information such as stock ticker data or operating software updates for the system receiver. And in some cases, a “program” is an individual episode or edition of an episodic presentation. For example, an episodic news service (e.g., ABC News) typically produces new episodes (editions) with updated program content (e.g., the most current news) at certain time intervals (e.g., every hour). Each program is associated with an identifier (e.g., program number).

The programs are typically produced, digitized, and stored in a suitable medium prior to being accessed for broadcast. For example, three programs carrying identifier numbers 3,17,325 are audio programs that are produced in a conventional audio program production studio (not shown) such as a recording studio. The programs are either produced in or converted to digital format and stored using, for example, magnetic disk storage and a conventional data base (not shown). A human operator creates a program broadcast schedule and configures software resident on a conventional computer platform with the schedule (the configured software and hardware combination acting as a “broadcast manager”). The broadcast manager in turn causes additional software resident on a conventional computer platform (this software and hardware combination acting as a “distribution server”) to access the stored programs from the database in accordance with the broadcast schedule. The distribution server then formats (e.g., encodes, frames, and sequences) the accessed programs for broadcast. The formatted programs may be compressed and encrypted. The distribution server subsequently passes the formatted programs to a wireless transmission facility (not shown) for broadcast. As shown in FIG. 2, thereby illustrative of a typical broadcast schedule, program number 17 is broadcast three times, program number 325 is broadcast once, and program number 3 is broadcast twice. Programs broadcast more than once are not necessarily broadcast contiguously.

Certain programs are deemed more time-sensitive than others. That is, some programs include time-sensitive information that is useful for a human listener/viewer to make an informed decision about performing a task, but the usefulness of the information degrades over a relatively short time (e.g., minutes). Such times-sensitive programs require frequent updates to ensure that they contain current information. Examples of highly time-sensitive information include motor vehicle traffic reports, severe weather reports, news, and stock price information. Examples of programs having less or no time-sensitivity are music, movies, or talk-radio shows.

In known live (real-time) radio or television broadcasts, time-sensitive information is updated at somewhat regular intervals and transmitted to listeners. Examples of such updates are motor vehicle traffic reports (typically broadcast on commercial FM stations every 10 minutes during peak traffic flow periods (“rush” hours) in urban areas), weather reports or alerts (e.g., tornado watch or warning reports), and general news. Despite program repetition in present on-demand systems, however, the present inventors have found that there does not exist any capability in present on-demand program systems for providing both such time-sensitive programs and updates to time-sensitive programs at a rate such that these time-sensitive programs/updates are available to the user a very short time (e.g., 60 secs.) after receiver power-up, or after the receiver moves out of an obstructed on-demand program signal path. For example, the present inventors have found that a receiver mounted in an automobile should provide current motor vehicle traffic reports to the listening driver as soon as possible after exiting a garage. Therefore, the present inventors have determined that what is required is a reliable system and method for providing time-sensitive program content to the mobile on-demand receiver as soon as the receiver is powered on, or as soon as a powered on receiver is located in a position to receive and extract the time-sensitive program content.

### SUMMARY

Short bursts of high priority programs for an on-demand system are broadcast at closely spaced time intervals. (“On demand” means that the receivers have local program storage and playback capability.) The communications channel is divided into a plurality of time segments. Each time segment is partitioned into a high priority program timeslice (time part) and a low priority program timeslice. High priority programs to be received by on-demand system receivers are broadcast in each high priority program timeslice. The remaining programs to be received by the receivers are broadcast over a plurality of low priority program timeslices.

In one embodiment the communications channel bandwidth is increased when system user demand (e.g., need) for the high priority programs is determined to be high. This dynamic bandwidth change is facilitated by using digital broadcast systems in which the system operator defines channel bandwidth within a government allocated frequency spectrum. In other embodiments the duty cycle of the high priority program timeslices is increased when system user demand for the high priority programs is high. Increasing the high priority program timeslice duty cycle or bandwidth allows a larger amount of high priority program information to be broadcast.

A system in accordance with the invention includes at least one program production facility for producing programs to be broadcast to the on-demand system users. A formatter formats programs received from the production facility(ies) for storage in a database. Stored programs are designated as being either high or low priority programs. A publication manager accesses the stored programs and passes high priority programs for broadcast during a high priority program timeslice to a channel server. Likewise, the publication manager passes low priority programs for broadcast during a series of low priority program timeslices to the channel server. The channel server frames and interleaves into a program stream the high and low priority programs for broadcast and passes the program stream to a channel multiplexer. The multiplex signal is broadcast to receivers either as a terrestrial or a satellite signal by a transmission facility.

### BRIEF DESCRIPTION OF THE DRAWINGS

FIG. 1 illustrates a wireless signal reception problem this disclosure addresses.

FIG. 2 is a diagrammatic view of a signal structure.

FIGS. 3A, 3B, and 3C are diagrammatic views of a channel structure in accordance with the invention.

FIGS. 4A, 4B, and 4C illustrate broadcast channel bandwidth allocation within a frequency spectrum.

FIG. 5 illustrates various timeslice duty cycles.

FIG. 6 is a diagrammatic view of an embodiment of a broadcast system.

FIG. 7 is a diagrammatic view of an embodiment of a receiver.

### DETAILED DESCRIPTION

Like numbers shown in the several drawings represent the same or substantially similar elements. Persons familiar with communications systems will understand that some well-known conventional elements have been omitted from the drawings and the accompanying disclosure so as to more clearly illustrate features of the invention.

FIG. 3A is a diagrammatic view illustrating information content (payload) carried by a wireless signal in a channel 300. The term “channel” should be broadly construed to be a path on which information is carried, and includes time, frequency, and code division separation from other parallel channels existing within a particular government allocated frequency spectrum. Channel 300 is, for example, a digital broadcast channel defined under IBOC, hybrid IBOC, XM Satellite Radio, Sirius Satellite Radio, or Eureka-147 standards. In other embodiments channel 300 is defined by a sideband, FM subcarrier, or other frequency spectrum division of a commercial broadcast radio or television system, including digital television systems. The symbol “t” with the accompanying arrow represents time in FIGS. 3A-3C.

As shown in FIG. 3A, channel 300 is divided into a plurality of time segments, illustrated as segments 302a-302d (segment 302d is only partially shown to illustrate the continuing nature of information broadcast on channel 300). In the FIG. 3A embodiment, segments 302a-302d are of equal duration so that the start time of each segment is periodic (e.g., synchronous segments). In another embodiment, segments 302a-302d are asynchronous. Each segment 302a-302d is divided into a high priority program timeslice (time part) and a low priority program timeslice (time part). Thus, segment 302a is divided into high priority program timeslice 304a and low priority program timeslice 306a. Segments 302b, 302c, 302d are divided into high priority and low priority program timeslice pairs 304b-306b, 304c-306c, 304d-306d, respectively. In other embodiments each time segment is partitioned into timeslices with more than two priority levels (e.g., low, medium, and high priority timeslices).The following disclosure is limited to describing embodiments using timeslicies with two priorities, but embodiments using more than two timeslice priorities are easily made in light of this disclosure.

In accordance with the invention, the content of each program broadcast by the on-demand system is digitized and the digitized program content is broadcast to receivers for local storage and playback (output) to a user. The digitized content of programs designated for high priority broadcast is inserted into the channel 300 high priority program timeslices, whereas digitized program content for programs designated for low priority broadcast are inserted into the channel 300 low priority program timeslices. The manner of making such high priority and low priority program designations is described below.

The high priority and low priority program timeslices of each time segment may carry one program, more than one program, or a part of a program. FIG. 3B illustrates low priority program content carried by channel 300. As shown in FIG. 3B, in accordance with the invention programs 310, 312, 314, 316 are designated for low priority broadcast. Therefore, programs 310, 312, 314, 316 are inserted into a series of channel 300 low priority program timeslices. In this illustration, the aggregate (combined) data size (bits) of programs 310 and 312 can be broadcast during a single low priority program timeslice, and so programs 310, 312 data are inserted into low priority program timeslice 306a. The data size of program 314 requires a broadcast duration longer than the duration of low priority program timeslice 306b. In accordance with the invention, program 314 is divided into two portions 314a, 314b. First portion 314a is inserted into low priority program timeslice 306b and second portion 314b is inserted into low priority program timeslice 306c. Portion 314b requires a broadcast duration shorter than the remaining duration of low priority program timeslice 306c, and therefore data for program 316 is also inserted into low priority program timeslice 306c. FIG. 3B is illustrative in practice there may exist many more programs designated for low priority broadcast than are shown in FIG. 3B. The manner of scheduling each low priority program for broadcast is discussed below. In one embodiment, all designated low priority programs are broadcast once before being broadcast a second time. That is, in channel 300 a stack of low priority programs is inserted into the low priority timeslices 304 as the timeslices 304 become available. After the entire stack of low priority programs is broadcast one time, a second broadcast cycle of programs in the low priority program stack begins.

FIG. 3C illustrates high priority program content carried by channel 300. In accordance with the invention, programs 320, 322, 324, 326, 328, 330, 332, and 334 (collectively, the high priority programs 336) are designated for high priority broadcast.. The manner of designating high priority programs is described below. As shown in FIG. 3C, high priority programs 336 data are inserted into each unique high priority program timeslice 304a, 304b, 304c, 304d. Therefore, during broadcast of a single stack of low priority programs as illustrated in FIG. 3B, high priority programs are broadcast many times as illustrated in FIG. 3C. FIGS. 3B and 3C are shown separate for clarity, but it should be understood that both high priority and low priority programs are inserted into the one channel 300. The number of high priority programs shown in FIG. 3C is illustrative, and more or Sewer high priority programs may be included as high priority programs 336.

At some times during system operation, the data size of high priority programs 336 may either be less than or exceed the data capacity of a high priority program timeslice 304. For example, the timeslice 304 duration may be too short to accommodate high priority program 334 which is the last of the high priority programs in the stack illustrated in FIG. 3C. In this situation, program 304 may be split into two parts and broadcast in two high priority program timeslices in a manner similar to the splitting and broadcast of low priority program 314 as described above with reference to FIG. 3B. In other embodiments the duty cycle and/or bandwidth of the high priority program timeslice is changed as described below to allow broadcast of all high priority programs. In still other embodiments, the compression applied to high priority programs is increased (with potential loss of media output fidelity to the user) in order to decrease program data size and thereby allow all high priority to be broadcast in fewer high priority timeslices. The receiver associated with the broadcast system is capable of recovering compressed program content for the applied compression techniques.

In some embodiments, the segment 302a-302d duration and high priority program timeslice 304a-304d duration are varied over time. For example, in one embodiment the segment 302a-302d duration is 60 seconds and the timeslice 304a-304d duration is 10 seconds. Thus, a high priority program timeslice is repeated every 60 seconds. The ratio of the high priority program timeslice duration T_{H} to the repetition period TR between start times of the high priority program timeslices (i.e., the segment duration) is the high priority program timeslice duty cycle (T_{H}:T_{R}). For an illustrative T_{H}=10 secs. and T_{R}=60 secs., the duty cycle is 1:6. A high priority program timeslice duty cycle is increased by increasing the duration of the high priority program timeslice or by decreasing the duration of the time segment that includes the high priority program timeslice.

In some embodiments the segment duration and high priority program timeslice duration vary within a larger time span, such as within a day or a week. Such variations accommodate perceived time variations in user demand for the high priority programs. Referring to FIGS. 3A-3C, for example, in one embodiment the segment 302a-302d durations during “rush” hours (peak motor vehicle traffic times) are relatively short (e.g., 60 secs.) but are longer (e.g., 10 mins.) during non-peak motor vehicle traffic times (e.g., night, weekends). Thus a motor vehicle traffic report carried in high priority program timeslices 304a-304d is repeated more often during rush hours than during non-peak traffic times since there is more demand during rush hours. Accordingly, low priority program throughput is increased during the times in which the high priority program timeslice duty cycle is reduced.

FIG. 5 illustrates embodiments in which the high priority program timeslice duty cycle is varied, either by changing the duration of the high priority program timeslice within a time segment, or by changing the time segment duration. As shown in FIG. 5, channel 502 is divided into high priority program timeslices 504 and low priority program timeslices 506. Channel 502 represents a baseline for comparison having a high priority program timeslice duration of t₁-t₂, a low priority program timeslice duration of t₂-t₃, and a segment duration of t₁-t₃.

Channel 512 illustrates an embodiment in which the high priority program timeslice duty cycle is increased. Similar to channel 502, the time segment duration in channel 510 is t₁-t₃. But for channel 512, high priority program timeslice 514 duration t₁-t₄ is increased to be longer than the timeslice 504 duration. Consequently, low priority timeslice 516 duration t₄ -t₃ is decreased from timeslice 506.

Channel 522 illustrates an embodiment in which the time segment duration is increased over the segment duration of the baseline channel 502. Similar to channel 502, the high priority program timeslice duration is t₁-t₂. But for channel 522, the segment duration t₁-t₅ is increased to be longer than the t₁-t₃ segment duration in channel 502. Thus high priority program timeslices 504,524 have similar durations, but the low priority program timeslice 526 duration is longer than the low priority program timeslice 506 duration.

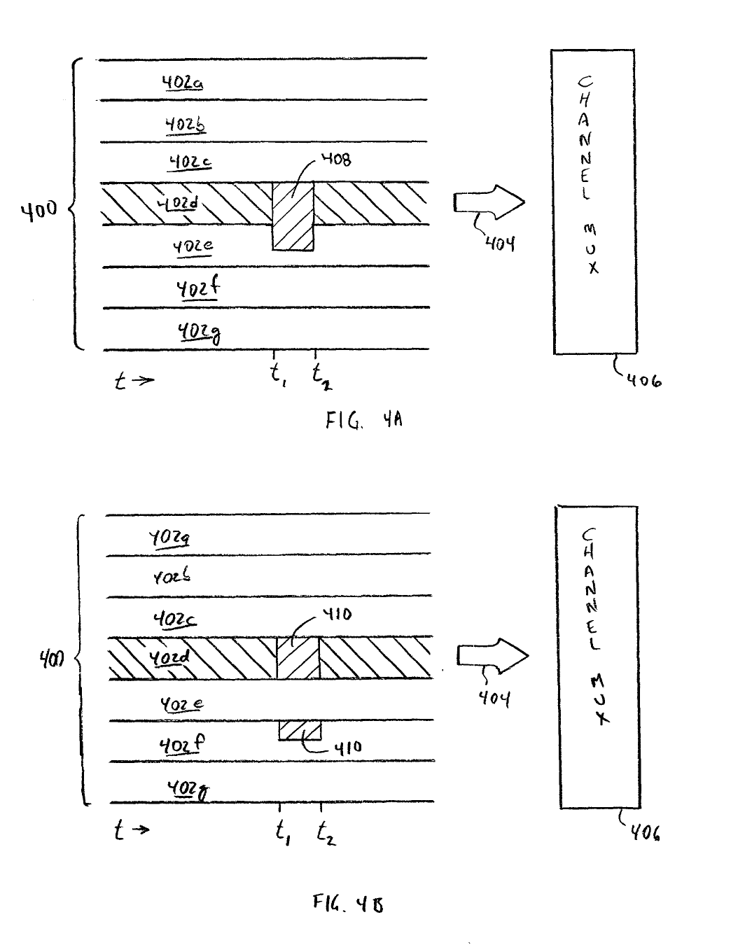

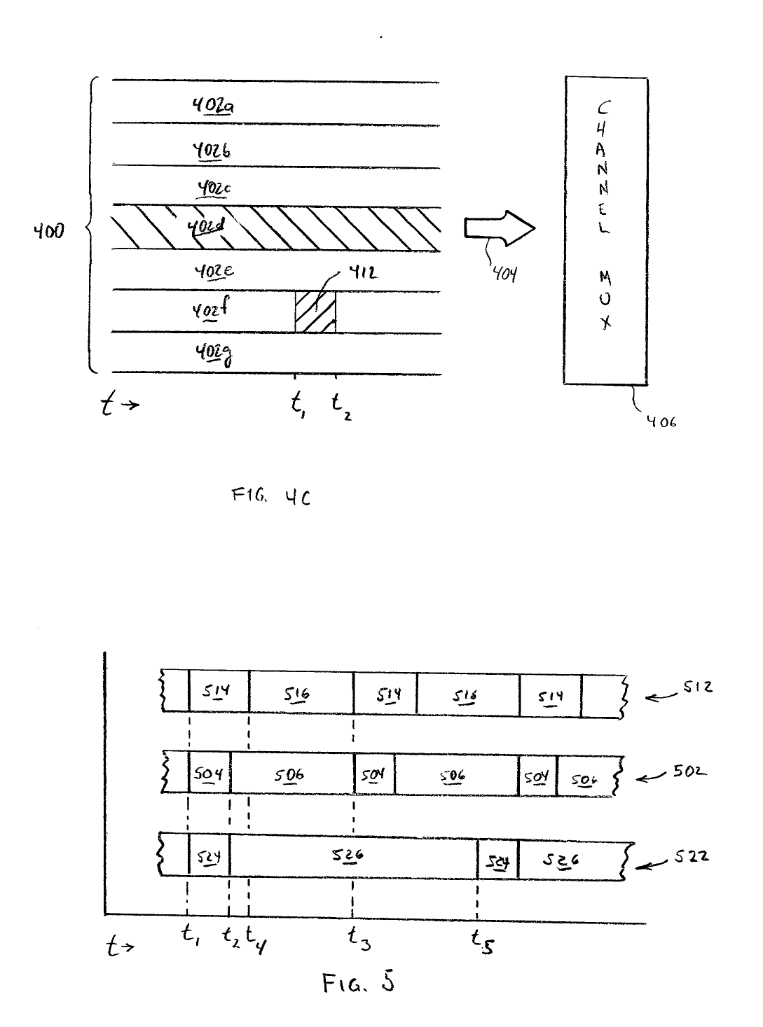

In some embodiments the bandwidth (i.e., data carrying capacity per unit time) of the channel carrying the high priority and low priority program timeslices varies with time. Such bandwidth variations accommodate perceived time variations in user demand for the high priority programs. FIG. 4A depicts a frequency spectrum 400, such as a spectrum allocated to the commercial XM Satellite Radio system or to a broadcaster operating under the Eureka-147 standard. FIG. 4A further depicts frequency spectrum 400 partitioned into illustrative channels 402a-402g. Persons skilled in the art will understand that in many digital broadcast systems (e.g., XM Radio, Eureka-147) the system operator determines and can vary both the number of channels within the system's allocated spectrum and the bandwidth of each channel. Therefore, in embodiments in which an ensemble of multiplexed channels is broadcast within spectrum 400 (e.g., Eureka-147), channels 402a-402g are passed (as illustrated by large arrow 404) to conventional channel multiplexer 406 for conventional multiplexing (e.g., code division) before wireless broadcast in accordance with the broadcast standard.

In some embodiments some or all of the bandwidth of a single channel defined in spectrum 400D is used to carry both high priority and low priority timeslices such as those discussed above with reference to FIGS. 3A-3C. It is well-known, however, that in some digital information broadcast formats that a broadcast system operator has the capability to specify and change in real time the data carrying capacity of individual channels within the broadcaster's allocated frequency bandwidth. For example, Eureka-147 systems typically have 7 or 8 channels, and the XM Satellite Radio system allows up to 255 channels. Therefore, in an embodiment illustrated by FIG. 4A, channel bandwidth of a selected channel is dynamically increased during a high priority program timeslice broadcast.

In some cases a broadcaster uses fewer than all available channels within the broadcaster's allocated spectrum 400. As shown in FIG. 4A, for example, channels 402b, 402d, and 402f may be digital data payload channels, while channels 402a, 402c, 402e, and 402g remain unused. Thus, in this example, if channel 402d is carrying the high priority and low priority program timeslice payloads, when a high priority timeslice 408 begins at time t1, channel 402d bandwidth is expanded to include at least a portion of unused channel 402e bandwidth. The channel 402d bandwidth remains increased during the high priority program timeslice until time t₂, at which time the channel 402d bandwidth returns to the normal channel 402d bandwidth during the low priority program timeslice. In some cases channel 402e is a payload channel, in which case the channel 402e bandwidth is reduced between times t₁ and t₂ during broadcast of high priority program timeslice 408. In some embodiments, the channel 402d bandwidth is expanded into more than one additional channel.

FIG. 4B illustrates that the channel bandwidth during high priority program timeslice 410 broadcast does not have to expand into a channel adjacent the payload channel carrying the high priority and low priority program timeslices. As shown in FIG. 4B, at least a portion of channel 402f is used to carry the expanded bandwidth of channel 402d during the high priority program timeslice broadcast. FIG. 4B illustrates some digital broadcast systems that use a primary channel (e.g., channel 402d) that occupies most of the allocated frequency spectrum 400, plus an auxiliary channel that can expand or contract its channel bandwidth within the unused portions of frequency spectrum 400. FIGS. 4A and 4B combined further illustrate that in one embodiment, the bandwidth of the channel carrying the high priority program timeslice is expanded to include all available bandwidth in spectrum 400.

FIG. 4C illustrates another embodiment in which, within frequency spectrum 400, low priority programs are broadcast in channel 402d and high priority programs are broadcast in discrete timeslices in separate channel 402f (only one representative timeslice 412 is shown between times ti and t₂). In some embodiments the channel 402f bandwidth is expanded to include the bandwidth of one or more other payload channels (e.g., channels 402a-e and 402g) similar to the way the data carrying capacity is expanded in high priority program timeslices 408 (FIG. 4A) or 410 (FIG. 4B).

As illustrated by FIGS. 4A-4C and the accompanying text, low priority programs for the on-demand system are broadcast on at least one payload channel and high priority programs for the on-demand system are broadcast in discrete timeslices on at least one payload channel. In some cases the channel bandwidth allocated to these discrete high priority program timeslices includes some or all of the payload channel bandwidth carrying the low priority programs. In some cases the bandwidth allocated to these discrete high priority program timeslices is increased to more than the bandwidth of the payload channel carrying the low priority programs by allocating bandwidth of other channels (either payload channels carrying other information or unused channels) for use in carrying high priority programs. Persons skilled in the art will understand that more than one payload channel may be used to simultaneously broadcast low priority as well as high priority programs. Persons skilled in the art will also understand that the allocation of increased bandwidth to the high priority program timeslice broadcasts may be from channels defined in other frequency spectra.

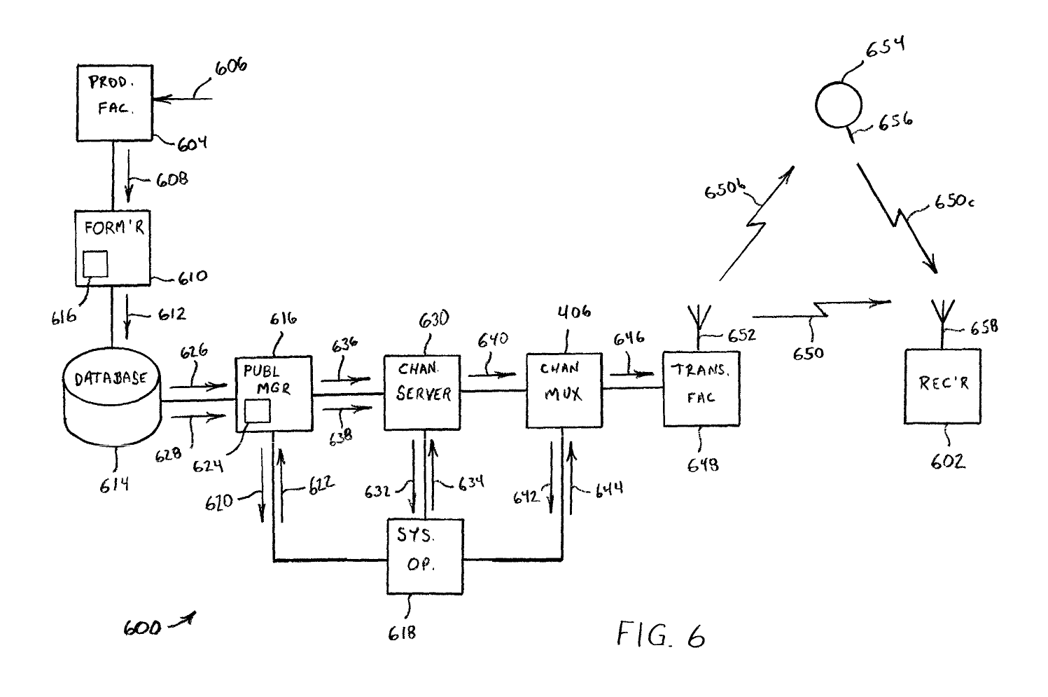

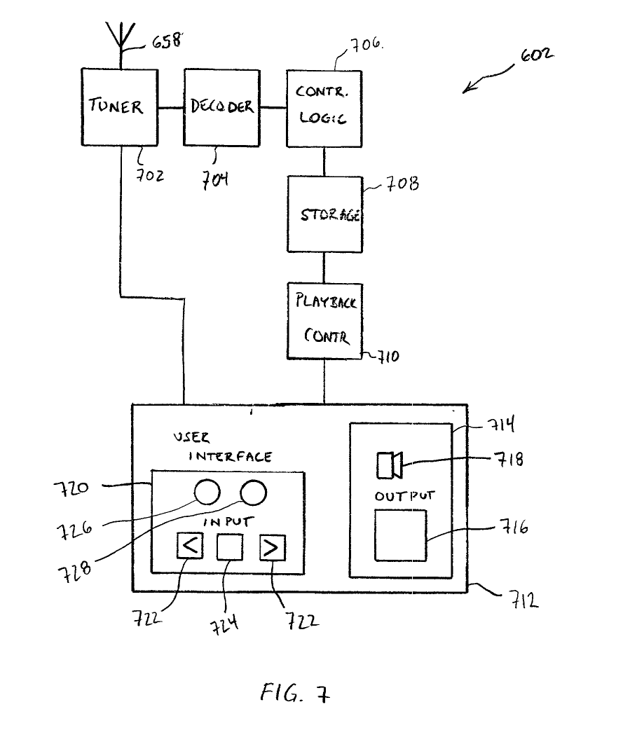

FIG. 6 is a diagrammatic view of an on-demand wireless broadcast system 600, which is an embodiment that produces, formats, stores, sequences for broadcast, and broadcasts high priority and low priority programs in accordance with the invention. FIG. 6 also shows receiver 602 that receives programs broadcast by system 600, and then stores the received programs for subsequent output to the user.

Production facility 604 creates both high and low priority programs (e.g., programs that are either stand-alone or are editions of an episodic presentation such as news) for broadcast. The single production facility 604 depicted in FIG. 6 is illustrative of one or more facilities that produce programs for broadcast in accordance with the invention. In one instance facility 604 is a conventional media studio (e.g., audio or video recording studio) in which programs are conventionally created. One illustrative program is created by a person announcing vehicle traffic or weather information. Other examples of production facility 604 include conventional facilities that create video or multimedia programs. In still other cases, production facility 604 receives one or more programs 606 created by a different source (e.g., prerecorded audio or video program, financial stock price information) and processes (e.g., adds meta-information, described below) the received program 606 so that it can be broadcast in accordance with the invention.

In some embodiments the production facility 604 that produces repeat programs is local to the area for which the particular repeat program is of interest to consumers. For example, programs containing local weather and motor vehicle traffic reports are produced by one or more facilities 604 located in sub-areas (e.g., a city) of the entire system 600 geographic service area (e.g., commercial satellite digital audio radio (SDAR) service area). Thus a first production facility 604 located in a first city produces repeat programs for the first city listeners/viewers, a second production facility 604 in a second city produces repeat programs for the second city listeners/viewers, and a third production facility 604 at another location produces programs for all system 600 listeners/viewers.

Production facility 604 passes (e.g., transmits via conventional land line) produced programs 608 to formatter 610. Each produced program 608 is in a data format corresponding to the program 608 content. For example, in some instances audio content is in uncompressed pulse code modulated (PCM) format, still images are compressed as Joint Photographic Experts Group (JPEG) files, text information is in ASCII format, and video (moving images) is in Audio/Video Interface (AVI), Moving Picture Experts Group (MPEG), or QuickTime (developed by Apple Computer, Inc.) formats. Other data formats may be used.

Each program 608 produced by facility 604 is associated with a corresponding program identifier (e.g., a number). A program creation date-time group (DTG) is also associated with each program produced or processed by facility 604 and is used to identify specific program editions in episodic presentations. Time-sensitive presentations require frequent updates to ensure the information in the time-sensitive presentation is as current as possible. Therefore, in some embodiments production facility 604 produces new program editions (updates) of time-sensitive presentations to be broadcast. Updated time-sensitive program editions have the same program identifier as earlier editions, but have a creation DTG that is later than the earlier editions. In one embodiment production facility 604 provides an edition number associated with a produced program 608 to formatter 610. The edition number is similar to the creation DTG since the edition number identifies the most recent program edition, and the edition number can be used as a replacement for, or in addition to, the creation DTG.

The program identifier and creation DTG are passed to formatter 610 in a data header along with the digitized program content. Thus formatter 610 identifies the content of each program 608 received from one or more than one production facility 604 by determining the identifier and creation DTG of the received program 608.

Formatter 610 is a conventional computer platform on which is resident software operating in accordance with the methods disclosed here. Formatter 610 processes programs received from facility 604 and passes formatted programs 612 to database 614 for storage as data files. Formatter 610 also associates certain program attributes (meta information) with each unique program, and passes these associated program attributes to database 614 as header information in frames carrying the program content to be stored.

Formatter 610 includes an attribute table, stored in conventional memory 616, containing program attributes for each unique program 608 received by formatter 610. TABLE I illustrates an embodiment of the attribute table stored in memory 616.

TABLE I

| Program Identifier; Name | Creation | Expiration | Compression |
|---|---|---|---|
| 1001; Dr. Laura | Aug. 13, 2000 08:22 | Aug. 17, 2000 14:34 | ACELP |
| (Listener call-in) | | | |
| 1002; Phoenix AZ Traffic | Aug. 16, 2000 15:43 | Aug. 16, 2000 16:43 | ACELP |
| 1003; Phoenix AZ News | Aug. 16, 2000 12:50 | Aug. 16, 2000 18:34 | ACELP |
| 1004; All Things Considered | Aug. 14, 2000 13:00 | Aug. 17, 2000 14:34 | ACELP |
| (National/World News) | | | |

The program identifier field contains program identifiers as described above. In some embodiments the identifier field includes the program name as text to be associated with the program stored in database 614. The program identifier field information is preloaded in formatter 610 so that identifier information received with a received program 608 may be compared against program identifiers in the attribute table.

The creation field contains the creation DTG (illustrated as Month/Day/Year Hours:Minutes) for the received program. Creation field information is updated from the creation DTG information with received program 608. In some cases facility 604 does not associate a creation DTG with a produced program 608, and therefore formatter 610 associates an arbitrary (e.g., time formatter 610 receives program 608) creation DTG with received program 608.

The expiration field contains an expiration date-time group (DTG) that is the date and time that a program is considered expired and will no longer be scheduled for broadcast in accordance with the invention. In one embodiment the expiration field information is loaded from an external source into the attribute table to establish the program expiration time. In another embodiment production facility 604 assigns an expiration DTG to a particular program and passes the expiration DTG to formatter 610 with program 608. The attribute table is then updated with the expiration DTG information from received program 608.

The compression field contains the compression type to be applied to the received program before storage in database 614. This information is determined by matching the received program identifier against the table record containing the same identifier. The compression scheme to be used for each unique program is chosen based on the service (e.g., output fidelity) to be delivered to the listener/viewer (e.g., for “CD” (compact disc) quality audio output an MPEG 2 Layer 3 (MP3) or DOLBY® AC3 compression is used). As described above, some program content is compressed by facility 604 using, for example, conventional JPEG or MPEG coding. Some program content, however, is not compressed by facility 604. In such cases, formatter 610 compresses the received program content using the compression scheme associated with the received program's identifier in the attribute table. For example, in one embodiment audio recordings are converted from pulse code modulated (PCM) digital audio format to compressed format using the G.179 (ITU-U G.729 voice coder definition) standard Algebraic Code Excited Linear Prediction (ACELP) voice coding at 6.4, 8, or 11.8 kilobits per second (kbps) format prior to storage. Other voice coder or data compression schemes may be used. Thus program content data compression occurs at either facility 604 or, if required, at formatter 610 so as to place the content in a compression format compatible for storage and output by the on-demand receiver 602 associated with on-demand system 600.

Formatter 610 also associates additional program attributes with the formatted programs 612 that are passed to database 614. This additional meta-information may include the creation DTG (and/or an edition number), a text identifier, and a program size attribute with each unique formatted program 612, in addition to the identifier, expiration DTG, and compression attributes.

The program size attribute is expressed in bits, but other measures (e.g., Bytes, number of packets) may be used.

Database 614 is a conventional computer platform on which is resident database management software that arranges and stores formatted programs 612. The digitized content of programs 612 is stored as data files in database 614. In some embodiments the unique identifier, creation and expiration DTGs, edition number, compression type, and program size attributes are stored as header information associated with each unique data file containing a unique program. In other embodiments the unique program attributes associated with each unique program are stored in a single table stored in database 614 so as to allow easier (e.g., faster) access to the files storing program content.

In some embodiments, if database 614 receives a formatted program 612 having the same identifier as a previously stored program but a creation DTG that is different than the previously stored program, database 614 stores the most current program edition. Similarly, for programs using edition numbers to identify the most current program version, database 614 examines the formatted program 612 edition number to determine if the program 612 should be stored. In some embodiments database 614 overwrites older editions of a program with a newer program edition. In other embodiments database 614 stores current and previous program editions. An advantage to overwriting an older program edition with a more current program edition is that accessing the most current program content for broadcast is simplified since the accessing software does not have to determine which stored program edition to access and does not have to direct database 614 to remove (erase) the older program edition. Programs having an expiration DTG earlier than the present time are removed from database 614.

In one embodiment, programs, and information associated with the programs, are stored uncompressed in database 614. Data compression is applied after a stored program is retrieved from database 614. Thus, in some embodiments at least some formatter 610 functions are carried out after stored programs are retrieved for broadcast from database 614. However, storing compressed programs increases storage efficiency.

In accordance with the invention, programs are designated as either high or low priority for broadcast, and a priority attribute corresponding to this high or low priority designation is assigned to each unique program stored in database 614. For example, in one embodiment the priority attribute is either the number 1 or 2, with 1 signifying a high priority program and 2 signifying a low priority program. In another embodiment a larger range of priority attributes is used, for example 1-10 with 1 signifying the highest priority and 10 signifying the lowest priority. In this case, one range (e.g., 1-3) designates a high priority program and the remaining range (e.g., 4-10) designates a low priority program. Using such a range allows for additional prioritization within the high priority and low priority designations. Among high priority programs, for instance, a 1 priority attributes is higher priority than a 2 or 3 priority attribute and a 2 priority attribute is higher priority than a 3 priority attribute. In another embodiment in which more than high and low priority program timeslices are defined (e.g., high, medium, low), more than two program broadcast priorities are defined (e.g., high, medium, low) to correspond with broadcast in the respective priority program timeslices. One or more priority attributes are assigned to each program (e.g., 1-high, 2-medium, 3-low; or 1&2-high, 3&4-medium, 5-10-low).

Publication manager 616 is a conventional computer platform on which software is resident that operates in accordance with the methods disclosed here. Publication manager 616 is coupled to system operator 618. Information passing from publication manager 616 to system operator 618 and from system operator 618 to publication manager 614 is illustrated by signals 620, 622 respectively. Signal 622 includes information such as the priority attribute to be associated with each program stored in database 614. In some embodiments signal 622 also includes a schedule of programs to be broadcast so that the order of program broadcast is determined for a particular priority level. In some embodiments signal 622 includes the priority program duty cycle as described above in relation to FIGS. 3A-3C and 5, or channel data capacity allocations such as described above in relation to FIGS. 4A-4C. In some embodiments the information in signal 622 is stored as a publication table in conventional memory 624 in publication manager 616.

In some embodiments system operator 618 is a human operator inputting information that is included in signal 622 sent to publication manager 616 by using a conventional data terminal. In other embodiments system operator 618 is automated. Using such an automated embodiment facilitates changing priority attributes on a regular schedule. In some cases the priority table values vary with, e.g., time-of-day or day-of-week. Thus one or more particular programs or program editions (e.g., motor vehicle traffic reports) having high priority value during one time (e.g., during “rush” hour) are assigned a lower priority during other times (e.g., late at night). Using an automated operator 618 also facilitates timely varying duty cycle and bandwidth management as described above with reference to FIGS. 4A-4C and 5.

Publication manager 616 accesses stored programs in database 614, and passes (publishes) the accessed high priority programs 626 and low priority programs 628 to channel server 630. Thus, publication manager 616 accesses both programs for broadcast in the high priority program timeslices and programs for broadcast in the low priority program timeslices. High priority programs (including program editions) are broadcast multiple times (e.g., once per each high priority program timeslice).

Channel server 630 is a conventional computer platform on which is resident software operating in accordance with the methods disclosed here. Channel server 630 is coupled to system operator 618. Information passing from channel server 630 to system operator 618 and from system operator 618 to channel server 630 is illustrated by signals 632, 634 respectively. Channel server 630 receives the published high and low priority programs 636, 638 from publication manager 616, and packetizes, frames, and interleaves frames into timeslices (see e.g., FIGS. 3A-3C) for broadcasting. The timeslice interleaving into one or more output program streams is based on the duty cycle defined by system operator 618 which is passed via signal 634.

As shown in FIG. 6, channel server 630 passes (e.g., using conventional land lines) one or more framed and interleaved high and low priority program streams 640 to conventional channel multiplexer 4061, FIGS. 4A-4C). Each program stream is broadcast in a unique channel (see e.g., FIGS. 4A-4C) in the multiplex signal. Channel multiplexer 406 also typically receives information from other sources (not shown) for insertion into other channels of the multiplex signal. Channel multiplexer 406 is coupled to system operator 618. Information passing from channel multiplexer 406 to system operator 618 and from system operator 618 to channel multiplexer 406 is illustrated by signals 642, 644 respectively.

Channel multiplexer 406 performs a conventional modulation (e.g., Coded Orthogonal Frequency Division Multiplexing (COFDM) or 8-level digital vestigial sideband modulation (8VSB)) on the interleaved streams. Channel multiplexer 406 outputs multiplex signal 646 to conventional transmission facility 648 (e.g., IBOC or hybrid-IBOC transmitter, XM Satellite Radio uplink transmitter, Eureka-147 transmitter, digital video broadcast transmitter). For embodiments which do not use multiplex signals, the output program stream 640 is passed directly to transmission facility 648.

In some embodiments server 630 adds features such as conventional forward error checking, conventional encryption, conventional convolutional coding (e.g., Viterbi), and if required, conventional data compression. In alternate embodiments, features such as encryption are added by various other parts of system 600, such as by formatter 610 or publication manager 616. A high priority program is a program that the system operator designates to be broadcast in each high priority program timeslice or in as many high priority program timeslices as possible. In one embodiment publication manager 616 sets in database 614 the priority attribute associated with each stored program.

A binary state “broadcast” marker is associated with each program stored in database 614. In one embodiment, publication manager 616 controls high and low priority program broadcast by controlling the state of the broadcast markers for each program. For an upcoming duty cycle, publication manager 616 sets the broadcast markers to a “broadcast” state for both the high and low priority programs to be broadcast in the duty cycle. In some cases publication manager 616 sets the “broadcast” markers in accordance with a broadcast schedule received from system operator 618. In some embodiments publication manager 616 evaluates the sizes of stored programs and sets the “broadcast” markers to fill the available high and low priority program timeslice bandwidths. And in some embodiments publication manager 616 sets the “broadcast” markers based on the sub-priorities within the high and low priority program designations.

Then, publication manager 616 accesses the “broadcast” marked high priority programs and buffers at least a portion of the accessed high priority programs 626 for publication during a high priority program timeslice. Similarly, publication manager 616 accesses the “'broadcast” marked low priority programs and buffers at least a portion of the accessed low priority programs 628 for publication during a low priority program timeslice. Publication manager 616 resets the “broadcast” marker to a “no broadcast” state after accessing the associated stored program.

In some embodiments more than one “broadcast” marker is associated with each stored program, each “broadcast” marker being associated with a portion of the stored program. In this manner portions of a program are designated for broadcast in more than one timeslice, as described above with reference to programs 314 (FIG. 3B) and 334 (FIG. 3C).

In some embodiments publication manager 616 marks (designates) all low priority programs for broadcast one time before designating a low priority program for broadcast a second time. In some embodiments publication manager marks the low priority programs for broadcast in accordance with a schedule received from system operator 618. In some embodiments publication manager 616 marks low priority programs for broadcast according to the sub-priority attribute associated (e.g., 4-10) with the low priority programs.

In some embodiments publication manager 616 marks all high priority programs for broadcast in each high priority program timeslice. In other embodiments, publication manager 616 marks the high priority programs for broadcast in accordance with a scheduling algorithm. For example, in the case in which high priority programs are given 1, 2, and 3 sub-priorities, publication manager 616 marks priority 1 programs for broadcast in each high priority program timeslice, marks priority 2 programs for broadcast in every second high priority program timeslice, and marks priority 3 programs for broadcast in every third high priority program timeslice. Skilled artisans will be familiar with many scheduling algorithms that can be used to provide desired high priority program service to users. High priority program bandwidths and duty cycles may be varied to accommodate such scheduling algorithms.

Thus publication manager 616 manages broadcast of the stored programs by marking for each duty cycle the programs to be broadcast. After publication manager 616 has accessed programs for broadcast during a duty cycle, publication manager 616 then examines the “broadcast” markers. Any “broadcast” marker that has not been reset to a “no broadcast” state has not been accessed for broadcast.

In one embodiment, if all marked priority programs have not been broadcast, publication manager 616 then acts to increase the priority program duty cycle as described above with reference to FIGS. 3A-3C and 5 by sending a request to system operator 618 in signal 620 to increase the duty cycle. System operator 618 may respond by ignoring the request, by modifying the duty cycle to accommodate the request, and/or by increasing the channel bandwidth.

If modifying the duty cycle, system operator 618 sends to channel server 630 via signal 634 an instruction to increase the duty cycle. Channel server 630 acknowledges the instruction via signal 632. System operator 618 then sends to publication manager 616 via signal 622 information regarding the new duty cycle so that the proper high and low priority programs are accessed from database 614 and published to channel server 630.

If modifying the broadcast channel bandwidth, system operator 618 sends to channel multiplexer 406 via signal 644 a configuration request to increase the bandwidth of the channel carrying program stream 640. Channel multiplexer 406 acknowledges the instruction via signal 642. System operator 618 then sends to publication manager 616 via signal 622 information regarding the new bandwidth so that the proper high and low priority programs are accessed and published to channel server 630. System operator 618 also sends to channel server 630 via signal 634 information regarding the new bandwidth so that server 630 serves the new channel bandwidth with sufficient program information.

In a manner similar to that used if high priority timeslices cannot accommodate all high priority programs, high priority timeslice duty cycle and/or bandwidth are reduced if data overcapacity exists in the high priority program timeslice. If all high priority programs have been accessed for a particular duty cycle, publication manager 616 examines the aggregate size of the accessed high priority programs to determine if the priority program duty cycle or high priority program timeslice channel bandwidth should be decreased. By informing system operator 618 of over- or under-use of high priority program timeslices, system performance is optimized by adjusting the high priority program timeslice qualities to be just enough to broadcast all high priority programs. Adjusting the high priority timeslice qualities also prevents a situation in which some lower priority programs within the “high priority” designation are never broadcast.

Manager 616, channel server 630, and system operator 618 are shown separate in FIG. 6 to more clearly describe the invention. Skilled artisans will understand that publication management, channel service, and system operation actions in accordance with the invention may be carried out using a single computer platform.

Transmission facility 648 receives program stream 646 for broadcast. In one embodiment, transmission facility 648 broadcasts the received stream in wireless signal 650a via conventional transmission antenna 652. In embodiments in which transmission facility 648 is associated with a satellite broadcast system (e.g., XM, Sirius), transmission facility 648 transmits the received stream in satellite uplink signal 650b to earth-orbiting satellite 654. Satellite 654 receives wireless uplink signal 60b and repeats the program information in wireless downlink broadcast signal 650c, broadcast from conventional satellite transmitting antenna 656. Signals 650a-650c are structured to carry program content as described above with reference to FIGS. 3A-3C. In some embodiments transmission facility 648 broadcasts signal 650a as a terrestrial (earth-to-earth) digital video broadcast (DVB-T) signal. In some embodiments transmission facility 648 broadcasts signal 650b as a satellite (earth-satellite-earth) digital video broadcast (DVB-S) signal.

Receiver 602 is an on-demand receiver in accordance with the invention. Some receiver 602 embodiments receive broadcast signal 650a. Some receiver 602 embodiments receive broadcast signal 650c. Signals 650a or 650c are received via conventional antenna 658, and receiver 602 extracts content from the received signal and stores the extracted content for subsequent output to the user.

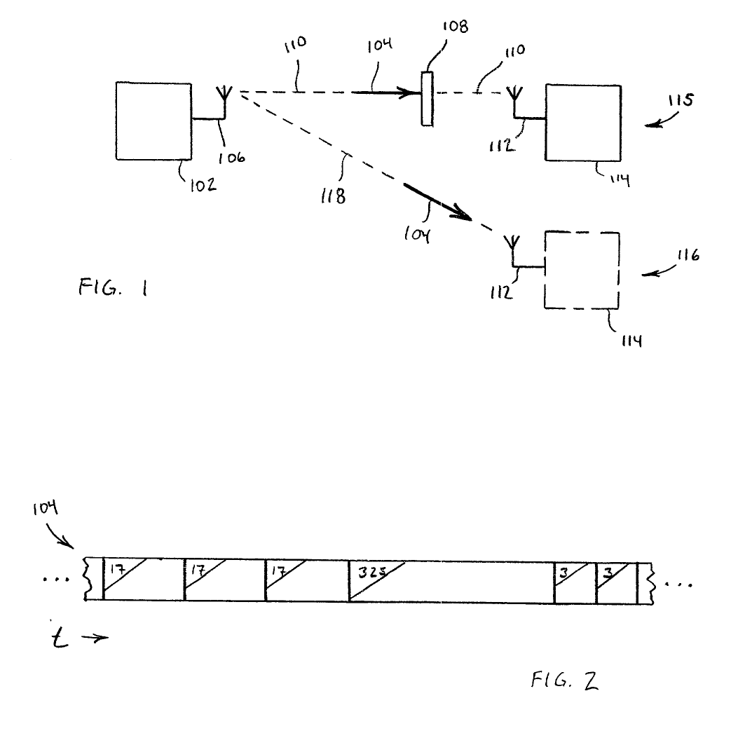

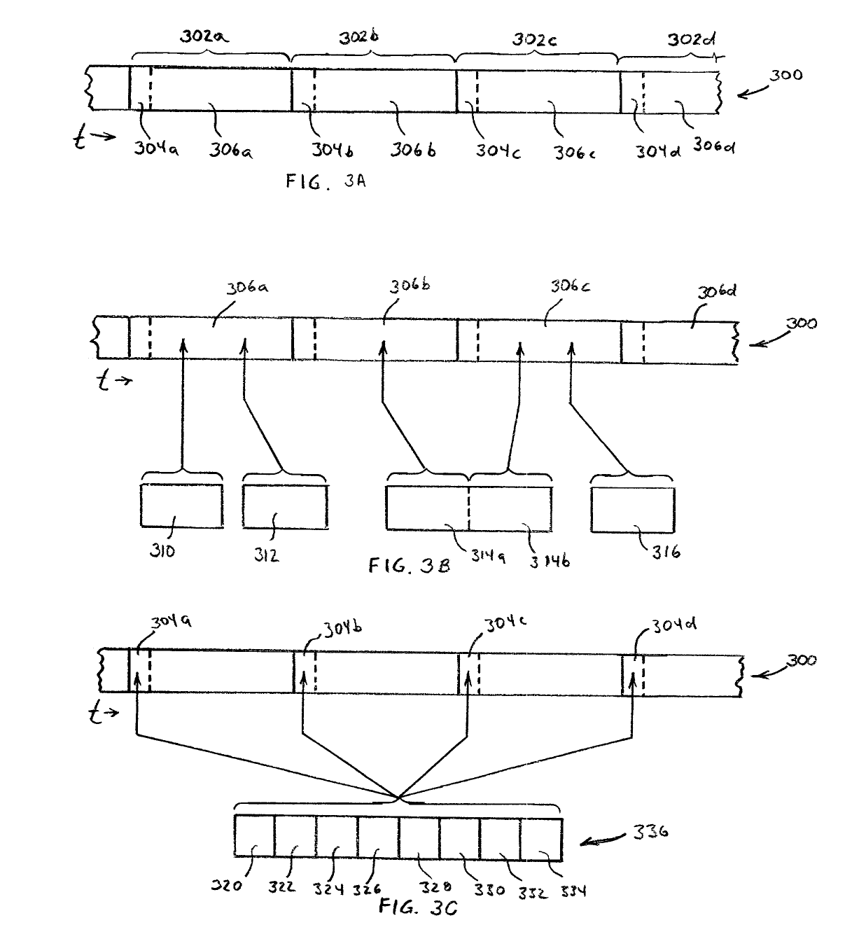

As depicted in FIG. 6, transmission antennas 652 and 656 are analogous to transmission antenna 106 (FIG. 1), and receiver antenna 658 is analogous to receiver antenna 112 (FIG. 1). Thus by repeatedly broadcasting high priority programs in high priority program timeslices, receiver 602 receives the high priority programs as soon as antenna 658 is positioned to receive a broadcast signal carrying the high priority program timeslice programs.

FIG. 7 is a diagrammatic view showing components of an illustrative receiver unit 602 in accordance with the invention. The receiver unit is typically mobile, being in some embodiments installed in a motor vehicle (in some cases integral with the vehicle radio) and in other embodiments being a hand-held portable unit. In one embodiment receiver unit 602 is powered either by a battery (not shown) or an external power source (not shown; e.g., conventional AC wall power or DC automobile power) that in some instances also recharges a receiver battery. The receiver can continuously operate (always powered on) when powered by a fixed power source and can thus may continuously receive a broadcast signal. When powered by a battery, however, there typically will be times when the receiver unit cannot receive the broadcast signal because the receiver unit is powered down to conserve battery power. Also, as discussed above with respect to FIG. 1, the receiver unit may not receive the broadcast signal due to a physical obstruction interfering with the signal path to the receiver unit's antenna 658.

Tuner 702 is conventional and receives a wireless signal (e.g., signals 650a or 650c (FIG. 6)) via antenna 658. Tuner 702 conventionally demodulates the received wireless signal. In some embodiments tuner 702 conventionally tunes to a single broadcast channel such as an IBOC or hybrid-IBOC channel. In other embodiments tuner 702 tunes to receive a frequency spectrum containing multiple channels (e.g., Sirius or XM proprietary systems, or Eureka-147 system). The Eureka-147 Fast Information Channel (FIC), and similar features in other systems, provides signal configuration information that allows tuner 702 to identify payload channels, to tune so as to receive full bandwidths of particular payload channels, or to accommodate other received signal configuration changes (e.g., add or delete channels). Thus tuner 702 tunes to receive one or more channels containing high and low priority program timeslices.

The demodulated signal is output to conventional decoder 704 (e.g., discrete integrated circuit, software executed by a conventional microprocessor) that decodes (e.g., deframes, applies conventional error checking) the demodulated signal. In some embodiments decoder 704 conventionally decompresses the demodulated signal and in other embodiments the program content is kept in a compressed format for storage in the receiver. In embodiments in which the program content is encrypted before broadcast (e.g., for a service that allows users access to certain programs only on a subscription basis), decoder 704 decrypts the demodulated program content. Following decompression and/or decryption, decoder 704 outputs the decoded signal to control logic 706. In one embodiment in which a single channel carrying the timeslices is received and the bandwidth of this channel changes as illustrated in FIG. 4A, information in the FIC allows tuner 702 to accommodate this bandwidth change. In multiple channel embodiments as illustrated in FIGS. 4B and 4C, tuner 702 and decoder 704 monitor the multiple channels containing timeslices and extract program information as the information arrives.

Control logic 706 is embodied in conventionally coded software/firmware executed, for example, by a conventional microprocessor/microcontroller (the terms here are equivalent). Control logic 706 controls the storage of the decoded program information in local (i.e., local to the receiver unit) storage 708. The decoded program information typically includes high and low priority program content. In some embodiments programs include information such as an index (“program guide”) of programs broadcast by the system or software used to operate the receiver.

Local storage 708 is conventional (e.g., NVRAM (such as a Toshiba Corp.'s NAND flash memory), disk drive) and stores the received and decoded digital program files as data files in a database. The decoded signal includes a program identifier associated with each received program as discussed above (e.g., in frame or packet headers). In one embodiment control logic 706 compares the received program identifier to the program identifiers of programs already stored in storage 708. If a received program is not stored, control logic 706 stores the newly received program. If the received program's identifier matches a stored program's identifier, control logic 706 examines the received program's creation DTG and/or edition number to determine if the received program is a more current version of the stored program. If the received program's creation DTG or edition number is later than the stored program DTG, control logic 708 replaces (or replaces updated portions of) the stored program with the newly received program. Each repeat program timeslice will typically contain one or more updates to programs stored in storage 708.

Playback control 710 is also embodied in conventionally coded software/firmware executed by a conventional microprocessor/microcontroller. Playback control 710 is controlled by user interface 712 in accordance with conventional user interface techniques. Playback control 710 conventionally accesses the program identifiers stored in storage 708 and uses the accessed identifiers to construct one or more menus of programs stored in storage 708. The menu(s) include(s) selections corresponding to each unique stored program. In some embodiments the menu selections are hierarchical such that a user first selects a broad program category (e.g., music) and then selects a more limited sub-category (e.g., classical music) before selecting a particular program for output. In some embodiments the menu is output using conventional visual display (e.g., LCD, TFT) 716. In other embodiments output unit 714 includes a conventional voice synthesizer (not shown) and each menu selection is a synthetic voice output via conventional audio speaker 718.

The user selects a particular stored program for output by using input unit 720 to choose a particular menu selection. In one embodiment the user conventionally scrolls through visible menu selections using “next” and “previous” scroll keys 722 and selects a particular program for output by pressing “play” key 724. When the user presses “play” key 724, playback control 710 accesses the selected program from storage 708, conventionally decompresses the accessed program if necessary, and outputs the accessed program to the user via output unit 714. In some embodiments key 724 is a “play/pause” key in which a first key press starts output of the selected program and the following key press pauses the program output while in progress.

In some embodiments input unit 720 includes a conventional voice recognition system and the user scrolls through audible menu selections by speaking commands (e.g., “forward,” “back”) into conventional microphone 726. The user then selects a particular program for playback by speaking a second command (e.g., “play”). In response to the spoken “play” command, playback control 710 accesses the selected program from storage 708 and outputs the accessed program to the user via output unit 714.

In some embodiments user interface 712 includes additional features such as conventional output parameter (e.g., volume, brightness) control 726 and conventional tuner control knob 728. In some embodiments the user operates tuner control knob to select among several broadcast channels (e.g., among several SDAR or ensemble multiplex channels) providing information in accordance with the invention. The user's channel selection is output via conventional electronic link 730 to tuner 702 which tunes to the selected broadcast channel in response to the user's selection. In other embodiments, tuner 702 scans the FIC to identify channels carrying programs in timeslices, and then automatically tunes to those channels. The depicted link 730 is illustrative and persons familiar with wireless systems will understand that link 730 may include conventional components such as a microprocessor.

Persons familiar with wireless systems will further understand that other conventional user interface inputs may be used to control reception, storage, and output of programs received via a wireless signal in accordance with this invention. For example, in one embodiment control logic 706 stores only the high priority programs by identifying each received program's identifier, conventionally comparing the received program's identifier against a preloaded table (e.g., loaded at receiver point of sale or via information received in another program that contains data used to operate the receiver) of programs to be stored, and storing only the programs whose identifiers match the identifiers in the table. In some embodiments in which only high priority programs are stored, control logic 706 and playback control output one or more low priority programs to the user immediately on receipt (e.g., streaming audio or video output), thus reducing the storage capacity requirements of storage 708 (persons familiar with streaming audio or video systems will understand that conventional buffering is generally required). In another embodiment, control logic 706 compares the identifiers of the received programs against a conventional preloaded table of identifiers, stores only low priority programs in storage 708, and immediately begins to output one or more high priority programs to the user. In yet another embodiment, the user operates interface 712 to designate certain programs in storage 708 for read-only status, thereby preventing control logic 706 from erasing these designated programs. New versions of a stored program (e.g., financial reports) are stored as separate data files. Playback control 710 accesses the creation DTG or edition number of each stored version and outputs a menu of selections corresponding to each creation DTG or edition number. The user then selects among the various program versions using input unit 720 as described above.

Software/firmware coding in accordance with the invention is routine in light of this description. Persons familiar with communications systems will understand that many variations exist of the embodiments described herein. For example, the software coded instructions described herein may in some cases be embodied as programmed memory integrated circuits. Accordingly, the scope of the invention is bound only by the following claims.

We claim:

1. A broadcasting method comprising the acts of:
storing a plurality of programs;
defining in a wireless communications channel a plurality of time segments, each time segment comprising a high priority time part and a low priority time part;
broadcasting a first set of stored programs in each high priority time part; and
broadcasting a second set of stored programs in a plurality of low priority time parts.

2. The method of claim 1 further comprising the act of increasing a first bandwidth of the channel during each high priority time part to a value larger than a second bandwidth of the channel during each low priority time part.

3. The method of claim 2, wherein increasing the first bandwidth of the channel comprises using at least a portion of a bandwidth of a second communications channel.

4. The method of claim 2, wherein increasing the first bandwidth of the channel comprises increasing the first bandwidth to a maximum allowable bandwidth in a government authorized frequency spectrum.

5. The method of claim 1 further comprising the act of increasing a bandwidth of a high priority time part during a first portion of a day.

6. The method of claim 1 further comprising the act of increasing a duty cycle of a particular high priority time part by increasing a duration of the particular high priority time part.

7. The method of claim 1 further comprising the act of decreasing a duty cycle of a particular high priority time part by increasing a duration of a time segment that includes the particular high priority time part.

8. The method of claim 1 wherein a first high priority time part duty cycle is defined during a first portion of a day, and a second high priority time part duty cycle, larger than the first high priority time part duty cycle, is defined during a second portion of the day.

9. The method of claim 1 further comprising the act of increasing a high priority time part duty cycle during a first portion of a day during which a user demand for reception and output of at least one of the first set of programs is larger than the user demand for reception and output of at least one of at least one of the first set of programs during a second portion of a day.

10. The method of claim 1 wherein the channel is defined as a channel in an ensemble multiplex signal comprising a plurality of channels.

11. The method of claim 1 wherein the channel is defined as a channel in a satellite broadcasting system.

12. The method of claim 1 wherein the channel is defined in a satellite digital video broadcast wireless signal.

13. The method of claim 1 wherein the channel is defined in a terrestrial digital video broadcast wireless signal.

14. The method of claim 1 wherein the channel is defined in an in-band on-channel signal or in a hybrid in-band on-channel signal.

15. The method of claim 1 wherein the channel is defined in a signal modulated using coded orthogonal frequency division multiplexing.

16. The method of claim 1 wherein the channel is defined in a signal modulated using 8-level digital vestigial sideband modulation.

17. The method of claim 1 wherein the first set of programs comprises at least one motor vehicle traffic report program.

18. The method of claim 1 wherein the first set of programs comprises at least one weather report program.

19. The method of claim 1 wherein the second set of programs comprises at least one audio program.

20. The method of claim 1 wherein the second set of programs comprises at least one video program.

21. The method of claim 1 wherein the first set of programs consists of a single program.

22. The method of claim 1 wherein the second set of programs consists of a single program.

23. A broadcasting system comprising:
a database configured to store a plurality of programs; and
a transmission facility coupled to receive the stored programs and configured to broadcast a wireless signal including the programs;
wherein the signal is associated with a communications channel, the communications channel being partitioned into a plurality of time segments, each time segment comprising a high priority time part and a low priority time part, a first set of programs received from the database being carried in each high priority time part, and a second set of programs received from the database being carried in a plurality of low priority time parts.

24. The system of claim 23, wherein a first bandwidth of the channel during each high priority time part is larger than a second bandwidth of the channel during each low priority time part.

25. The system of claim 24, wherein the first bandwidth of the channel comprises at least a portion of a bandwidth of a second communications channel associated with the signal.

26. The system of claim 24, wherein the first bandwidth of the channel comprises a maximum allowable bandwidth in a government authorized frequency spectrum.

27. The system of claim 23 wherein a duty cycle of a high priority time part is increased by increasing a duration of a particular high priority time part.

28. The system of claim 23 wherein a duty cycle of a high priority time part is decreased by increasing a duration of a time segment that includes a particular high priority time part.

29. The system of claim 23 wherein the signal comprises an ensemble multiplex signal comprising a plurality of channels, and wherein the communications channel is one of the ensemble multiplex signal channels.

30. The system of claim 23 wherein the channel is defined as a channel in a satellite broadcasting system.

31. The system of claim 23 wherein the signal is a satellite digital video broadcast signal.

32. The system of claim 23 wherein the signal is a terrestrial digital video broadcast signal.

33. The system of claim 23 wherein the signal is an in-band on-channel signal or a hybrid in-band on-channel signal.

34. The system of claim 23 wherein a modulation of the signal is coded orthogonal frequency division multiplexing.

35. The system of claim 23 wherein a modulation of the signal is 8-level digital vestigial sideband modulation.

36. The system of claim 23 wherein the first set of programs comprises at least one motor vehicle traffic report program.

37. The system of claim 23 wherein the first set of programs comprises at least one weather report program.

38. The system of claim 23 wherein the second set of programs comprises at least one audio program.

39. The system of claim 23 wherein the second set of programs comprises at least one video program.

40. The system of claim 23 wherein the first set of programs consists of a single program.

41. The system of claim 23 wherein the second set of programs consists of a single program.

42. A wireless broadcast signal, wherein the signal is associated with a communications channel, the communications channel being partitioned into a plurality of time segments, each time segment comprising a high priority time part and a low priority time part, a first set of programs received from the database being carried in each high priority time part, and a second set of programs received from the database being carried in a plurality of low priority time parts.

43. The signal of claim 42, wherein a first bandwidth of the channel during each high priority time part is larger than a second bandwidth of the channel during each low priority time part.

44. The signal of claim 43, wherein the first bandwidth of the channel comprises at least a portion of a bandwidth of a second communications channel associated with the signal.

45. The signal of claim 43, wherein the first bandwidth of the channel comprises a maximum allowable bandwidth in a government authorized frequency spectrum.

46. The signal of claim 42 wherein a duty cycle of a high priority time part is increased by increasing a duration of a particular high priority time part.

47. The signal of claim 42 wherein at duty cycle of a high priority time part is decreased by increasing a duration of a time segment that includes a particular high priority time part.

48. The signal of claim 42 wherein the signal comprises an ensemble multiplex signal comprising a plurality of channels, and wherein the communications channel is one of the ensemble multiplex signal channels.

49. The signal of claim 42 wherein the channel is defined as a channel in a satellite broadcasting system.

50. The signal of claim 42 wherein the signal is a satellite digital video broadcast signal.

51. The signal of claim 42 wherein the signal is a terrestrial digital video broadcast signal.

52. The signal of claim 42 wherein the signal is an in-band on-channel signal or a hybrid in-band on-channel signal.

53. The signal of claim 42 wherein a modulation of the signal is coded orthogonal frequency division multiplexing.

54. The signal of claim 42 wherein a modulation of the signal is 8-level digital vestigial sideband modulation.

55. The signal of claim 42 wherein the first set of programs comprises at least one motor vehicle traffic report program.

56. The signal of claim 42 wherein the first set of programs comprises at least one weather report program.

57. The signal of claim 42 wherein the second set of programs comprises at least one audio program.

58. The signal of claim 42 wherein the second set of programs comprises at least one video program.

59. The signal of claim 42 wherein the first set of programs consists of a single program.

60. The signal of claim 42 wherein the second set of programs consists of a single program.
